(19) United States
(12) Patent Application Publication
(10) Pub. No.: US 2017/0024742 A1
(43) Pub. Date: Jan. 26, 2017

(54) METHODS AND SYSTEMS FOR USING A CONSUMER IDENTITY TO PERFORM ELECTRONIC TRANSACTIONS

(71) Applicant: OmnyPay, Inc, San Francisco, CA (US)

(72) Inventors: Mohammad Khan, San Jose, CA (US); Ashok Narasimhan, San Francisco, CA (US); William N. Melton, San Francisco, CA (US)

(21) Appl. No.: 15/154,591

(22) Filed: May 13, 2016

Related U.S. Application Data
(60) Provisional application No. 62/161,190, filed on May 13, 2015.

(51) Int. Cl. G06Q 20/40; G06Q 20/32

(52) U.S. Cl. CPC G06Q 20/4014; G06Q 20/325; G06Q 20/4012

(57) ABSTRACT

According to one aspect, the subject matter described herein includes a method for using a consumer identity to perform electronic transactions. The method includes, at a mobile backend server, receiving user information that identifies a user of a mobile device distinct from the mobile backend server, using the user information to determine transaction information to be used to initiate an electronic transaction, and sending the transaction information to a point of interaction, distinct from the mobile device and the mobile backend server, for initiating the electronic transaction.

### RELATED APPLICATIONS

This application claims the benefit of provisional patent application Ser. No. 62/161,190, filed May 13, 2015, the disclosure of which is hereby incorporated herein by reference in its entirety.

### TECHNICAL FIELD

This disclosure relates to performing secure financial and non-financial electronic transactions made by consumers. More specifically, it relates to methods and systems for using a consumer identity to perform electronic transactions.

### BACKGROUND

Credit cards, debit cards, prepaid cards and other conventional instruments for making financial transactions have an inherent insecurity: namely, that sensitive information—i.e., information required in order to perform a transaction—such as information that directly or indirectly (e.g., through a token or a pointer) identifies the financial institution, the account at that institution, or the identity of the owner of that account, as well as passwords, personal identity numbers (PINs), expiration date, name, and the like—herein referred to as “payment information”—is transmitted between the point of sale (POS) terminal and the servers that receive and process this information, referred to as the “payment backend”. Despite measures taken to protect this sensitive information from being intercepted or viewed by unauthorized persons or entities that may misuse or illegally use such information, misappropriation and/or misuse of payment information for fraudulent transactions continues to be a problem.

Because sensitive information is being transmitted, the network, POS terminal, and mobile device must support additional complexity required to secure the sensitive information and protect it from unauthorized use. The data connection between a typical POS terminal, such as a card reader, for example, and a payment authorization network is increasingly encrypted, requiring a decryption key to view the encrypted data as plain text. Nevertheless, payment sensitive information was able to be stolen from the POS terminals/networks of multiple major department stores in the United States by thieves who installed into the POS terminal software (malware) that would intercept and store the magnetic stripe data (including the bank identifier, the bank account number, and the account owner's name)—e.g., everything needed to then illegally make purchases using the buyer's credit, debit, or prepaid card at physical stores and more frequently through online electronic commerce sites (i.e., online stores) globally. Thus, despite measures taken to obscure and protect sensitive information by payment industry security requirements, the fact remains that the sensitive information in large quantity can be stolen through POS terminals/networks, merchant databases, and other means and can be fraudulently played for a successful financial transaction.

This additional complexity is expensive, driving up development, deployment, and operational costs of all of the components. These costs are typically passed along to the users of the network in the form of higher transaction costs, which are ultimately borne by the merchants, primarily.

Another problem with conventional credit card reader transactions is that these systems use very primitive authentication systems to guarantee that the person making the transaction is who they say they are, i.e., to authenticate the user. For example, in physical stores environments, mostly credit and prepaid transactions, and less frequently debit card transactions performed at a point of sale terminal are typically done with a signature on a receipt and without requiring any authentication or verification of a buyer electronically, e.g., through an entry of his or her Personal Identification Number (PIN). Whereas most of the debit card transactions are typically done with the entry of a four-to-six digit PIN at a secured POS PIN pad reader. However, the trend is growing among buyers driven by convenience to use their debit cards without entering any PIN at POS and just providing a signature on a receipt. There continue to be increasing chances of fraud at physical POS using stolen credit, debit, and prepaid payment sensitive information due to lack of a buyer authentication at a POS. Although there is a wealth of other data that may be used to authenticate a person's identity, e.g., biometric data, passcodes or passphrases, digital signatures, etc., conventional POS terminals have no means to receive that data, much less use that data to authenticate the person performing the transaction

A bigger problem is with online electronic commerce stores where payment for online purchases are done remotely through entering payment sensitive information manually and without requiring buyers to provide almost no authentication or verification information today. This has been a major problem, and has provided very easy door for making fraudulent payment transactions with payment sensitive data stolen in large quantities from merchants' POS terminals/networks, databases, and through other means. This type of fraud is increasing globally; for example, payment sensitive data stolen from the United States could be used to make online purchases anywhere in the world.

Making on-line purchases at an e-commerce site can also be time consuming, requiring that the consumer enter a name, a shipping address, a billing address, a shipping preference, membership numbers, coupons or redeem codes, and so on. Web-based payment portals are essentially software front-ends to legacy payment networks, so ecommerce sites have no direct way to collect any kind of authentication information, e.g., the legacy payment networks expect to have the PIN mentioned above entered by a buyer on a physically secured PIN pad, which, in the case of ecommerce transactions, is not practically possible because of the remote presence between a buyer and an ecommerce site. Furthermore, since it is not necessary to physically possess a credit card, for example, to enter credit card data into an e-commerce site, such payment transactions are treated as a “card-not-present” payment transaction, which typically has a much higher transaction fee to a merchant than a “card present” payment transaction at a POS terminal.

While these concerns are usually raised in the context of financial transactions, it may be desirable to protect non-financial transactions as well. The problems of security and ease of use apply to all forms of electronic transactions, including both payment and non-payment electronic transactions.

What is needed, therefore, is a way for users to securely perform electronic transactions, both financial and non-financial, without exposing sensitive information to possible detection or interception. More specifically, there is a need for methods and systems for using a consumer identity to perform electronic transactions.

### SUMMARY

The subject matter disclosed herein includes methods and systems for using a consumer identity to perform electronic transactions.

According to one aspect, the subject matter described herein includes a method for using a consumer identity to perform electronic transactions. The method includes, at a mobile backend server, receiving user information that identifies a user of a mobile device distinct from the mobile backend server, using the user information to determine transaction information to be used to initiate an electronic transaction, and sending the transaction information to a point of interaction, distinct from the mobile device and the mobile backend server, for initiating the electronic transaction.

According to another aspect, the subject matter described herein includes a system for using a consumer identity to perform electronic transactions. The system includes a database for associating a user with transaction information, and a mobile backend server for receiving user information that identifies a user of a mobile device distinct from the mobile backend server, using the user information to query the database to determine transaction information to be used to initiate an electronic transaction, and sending the transaction information to a point of interaction, distinct from the mobile device and the mobile backend server, for initiating the electronic transaction.

According to yet another aspect, the subject matter described herein includes a computer program product for performing secure identity-authorized transactions. The computer program product includes a non-transitory computer readable storage medium having computer readable code embodied therewith, the computer readable code configured for receiving, at a mobile backend server, user information that identifies a user of a mobile device distinct from the mobile backend server, using, at the mobile backend server, the user information to determine transaction information to be used to initiate an electronic transaction, and sending, by the backend server, the transaction information to a point of interaction, distinct from the mobile device and the mobile backend server, for initiating the electronic transaction.

The subject matter described herein for using a consumer identity to perform electronic transactions may be implemented in hardware, software, firmware, or any combination thereof. As such, the terms “function” or “module” as used herein refer to hardware, software, and/or firmware for implementing the feature being described.

In one exemplary implementation, the subject matter described herein may be implemented using a computer readable medium having stored thereon executable instructions that when executed by the processor of a computer control the computer to perform steps. Exemplary computer readable media suitable for implementing the subject matter described herein include disk memory devices, chip memory devices, programmable logic devices, application specific integrated circuits, and other non-transitory storage media. In one implementation, the computer readable medium may include a memory accessible by a processor of a computer or other like device. The memory may include instructions executable by the processor for implementing any of the methods described herein. In addition, a computer readable medium that implements the subject matter described herein may be located on a single device or computing platform or may be distributed across multiple physical devices and/or computing platforms.

As used herein, the term “legacy payment information” refers to information that is provided to a merchant by legacy credit card systems, such as the user's primary account number, the user's name, and other information encoded within a magnetic stripe card.

### BRIEF DESCRIPTION OF THE DRAWINGS

Embodiments of the subject matter described herein will now be explained with reference to the accompanying drawings, wherein the like reference numerals represent like parts, of which:

FIG. 1 is a block diagram illustrating an exemplary system for using a consumer identity to perform electronic transactions according to an embodiment of the subject matter described herein;

FIGS. 2A, 2B, 2C, 2D, and 2E are signal messaging diagrams illustrating messages communicated among components of an exemplary system for using a consumer identity to perform electronic transactions according to embodiments of the subject matter described herein; and

FIG. 3 is a flow chart illustrating an exemplary process for using a consumer identity to perform electronic transactions according to an embodiment of the subject matter described herein.

### DETAILED DESCRIPTION

Methods and systems for using a consumer identity to perform electronic transactions are provided herein. In contrast to conventional payment systems that transmit legacy payment information to a physical store or point of sale (POS) terminal, the methods and system described herein leverage the functions and capabilities of most mobile devices and smart phones to authenticate a user such that, in order to effect a payment or non-payment electronic transaction, only the user's identity need be transmitted over potentially unsecure communications channels. There are several advantages to the methods and systems described herein. For example, since the systems and methods described herein avoid transmitting the kind of sensitive data typically transmitted by conventional payment systems, almost every component of the system, including the mobile device, the network itself, and payment entities, need not implement the complex and expensive security measures that today drive up the transaction costs to merchants using conventional systems. This is of particular benefit in developing countries, because it allows the implementation and use of simpler and/or cheaper payment networks.

The subject matter described herein is directed to the use of an authenticated consumer identity—rather than sensitive data—as the information transmitted in an unsecured or insecure environment. Once the authenticated consumer identity is received by a secure environment, such as a cloud-based network, the authenticated consumer identity may be used to determine, identify, or retrieve the sensitive transaction information (e.g., payment information), which is securely transmitted to the necessary entities to perform the desired electronic transaction. Other information may be passed along with the authenticated consumer identity, such as information that does not include sensitive payment information but can be used to determine sensitive payment information.

As will be described below, there are various ways that the identity of the consumer may be authenticated, various ways that the authentication may be performed, various entities that may perform the authentication, various ways that the authenticated consumer identity may be used to determine sensitive payment information, and various ways that the sensitive payment information may be conveyed to the point of interaction and/or the payment transaction network.

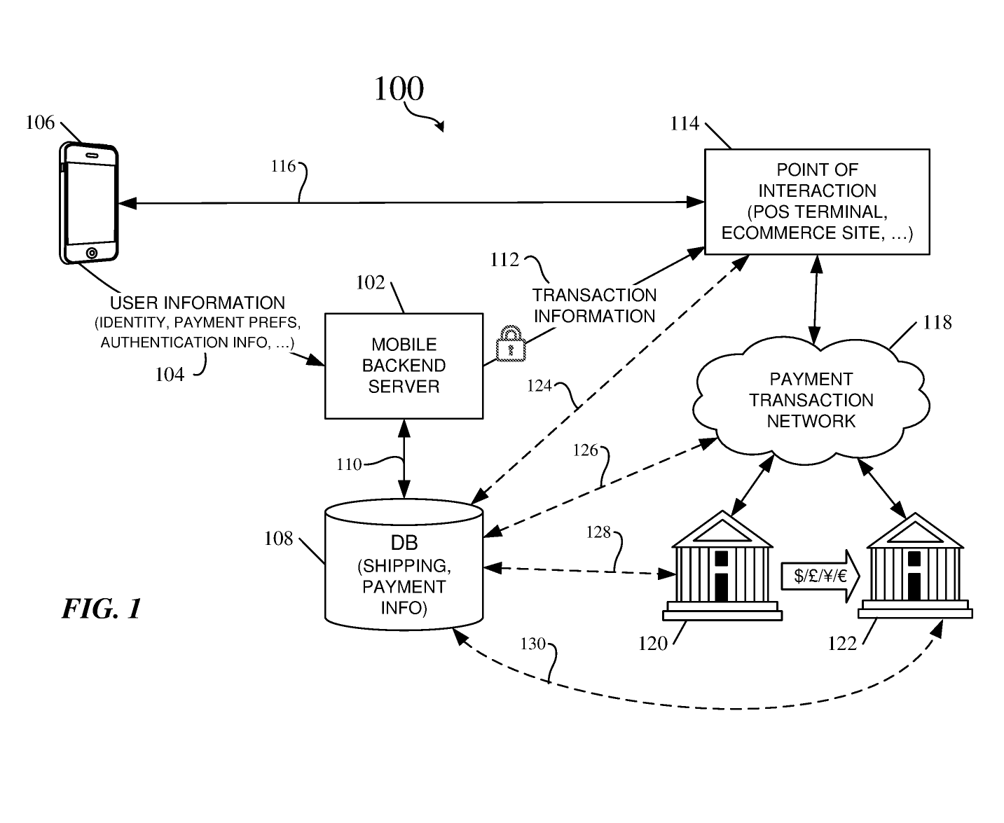

FIG. 1 is a block diagram illustrating an exemplary system for using a consumer identity to perform electronic transactions according to an embodiment of the subject matter described herein. In the embodiment illustrated in FIG. 1, system 100 includes a mobile backend server 102 for receiving user information 104 that identifies a user of a mobile device 106 distinct from mobile backend server 102. The concepts described herein are not limited to applications using a cellphone. Examples of mobile devices include, but are not limited to, cellphones, tablets, laptops, watches, wearable or other portable computers, and so on. In one embodiment, the mobile device may be a vehicle with mobile communication capability.

Mobile backend server 102 determines transaction information to be used to initiate an electronic transaction by querying a database 108 for associating a user with transaction information. In the embodiment illustrated in FIG. 1, mobile backend server 102 interacts with database 108 (e.g., via query/response 110) to retrieve transaction information 112, which is then sent to a point of interaction 114 for use to initiate an electronic transaction. In one embodiment, mobile backend server 102 may send to database 108 a query that includes some or all of user information 104, and may receive from database 108 a response that includes transaction information 112, a subset thereof, or a superset thereof.

In one embodiment, user information may be stored in database 108 as part of a registration process. For example, the user of mobile device 106 may use an application within mobile device 106 to connect with mobile backend server 102 for the purpose of collecting the information that will be stored within database 108. In one embodiment, the user uses the application to enter credit card information, e.g., by manual entry, by taking an image of the card, by swiping the card using a magstripe reader attached to mobile device 106, or other means. The application communicates that information to mobile backend server. Alternatively, the user may use a secure web portal to enter that information using mobile device 106, a personal computer, etc. In one embodiment, the user may be asked to enter additional information to authorize the card data. Examples of authentication information include, but are not limited to, the CVV or CVC number commonly printed on the back of many credit or debit cards, user ID, password, passcode, or personal information number (PIN), fingerprint or other biometric information, and so on. Other examples of biometric information include, but are not limited to, voice, facial recognition, eye/retina scans, typing style (speed, accuracy, word choice, etc.), and consumer behavior (e.g., does this person often engage in transactions such as the one being requested?) Where the mobile device is a vehicle with mobile communication capabilities, for example, a fingerprint sensor could be built into the steering wheel or the dashboard. Likewise, the functions of authentication and communication of the authenticated consumer identity may be shared or distributed between the consumer's vehicle and the consumer's cellphone. Other configurations are contemplated. This additional authentication information may or may not be stored within database 108, according to the rules and regulations as well as need for a particular kind of information.

In one embodiment, mobile backend server 102 may provide this authentication information along with transaction information 112. Other methods of populating database 108 are also within the subject matter described herein. The authentication information may be data that is used to perform the authentication (e.g., by mobile backend server 102 or another entity), an indication that the user was successfully authenticated, or both. In one embodiment, the fact that the authentication came from mobile device 106 (or from mobile backend server 102, later) may be considered sufficient proof of authenticity.

Point of interaction 114 may be, for example, a point of sale (POS) terminal, an ecommerce site, a mobile commerce site, a kiosk, a vending machine, a parking meter, or other entity with which a user of mobile device 106 may engage in an interaction 116, e.g., for the purpose of performing an electronic transaction. In one embodiment, the user's mobile device itself may be the point of interaction 114. In one embodiment, the point of interaction may be a passive entity that provides information that enables the mobile device 106 to perform the electronic transaction. Examples of passive entities include, but are not limited to, an image having a QR code which may be scanned by the mobile device 106, and an image, such as a picture of an item for sale, having data steganographically embedded into it such that the user of the mobile device 106 can take a picture of the item and an image analysis program can extract from the image the steganographic information. The OCR information/embedded information may be information associated with the object of the transaction (e.g., the item) such as information about the item itself and/or information about the seller. The electronic transaction may be a payment transaction or a non-payment transaction.

Initiating a transaction may involve performing the transaction or it may involve causing some other entity to perform the transaction. In the embodiment illustrated in FIG. 1, for example, point of interaction 114 may initiate an electronic transaction by communicating with a payment transaction network 118, which operates to effect a transfer of funds from the user/customer's bank or financial institution 120 to a merchant's bank or financial institution 122. In another embodiment, mobile backend server 102 may send transaction information 112 directly to payment transaction network 118, bypassing point of interaction 114. Transaction information 112 may contain some or all of user information 104.

For the sake of illustration of the concepts described herein, the example illustrated in FIG. 1 is an electronic payment transaction, but other electronic transactions, including both payment transactions and non-payment transactions, are also within the scope of the subject matter described herein. Examples of electronic transactions include, but are not limited to: a payment or purchase; a credit transaction; a debit transaction; a prepaid transaction; a deposit; a withdrawal; a money transfer; a transaction involving a loyalty program; a transaction involving a rewards program; and a transaction involving a diet, health, or fitness program. In one embodiment, the electronic transaction may be a payment transaction that is processed as a “card present” transaction. Likewise, the electronic transaction may be payment transaction that is processed as a “card not present” transaction. The methods and systems described herein may be applied to any electronic transaction where it is desirable to avoid transmission of sensitive data over a network as well as other forms of potential exposure to unauthorized entities.

Payment Information

In one embodiment, user information 104 includes payment information that is used to identify a payment instrument. In one embodiment, the payment information may include legacy payment information, such as primary account number, name of account number, and other data typically encoded within the magnetic stripe of a credit or debit card. In another embodiment, the payment information may include legacy payment information that has been encrypted. In yet another embodiment, the payment information may include a pointer to legacy information stored in a location that either mobile backend server 102 or point of interaction 114 may retrieve. In yet another embodiment, the payment information may include a payment preference—e.g., to select a credit card versus a debit card, to select a card from one financial institution versus from another financial institution, and so on—without including or specifying account numbers or other sensitive information. These examples are intended to be illustrative and not limiting. This information, too, may be encrypted or encoded for additional security. It should be noted that although the examples presented herein describe payment transactions, the same principles may be applied to non-payment transactions.

In yet another embodiment, the payment information may include a token that represents legacy payment information or that an entity may redeem in exchange for legacy payment information. For example, in one embodiment, at the time of a transaction, mobile backend server 102 may generate a token and pass that token to mobile device 106. Mobile device 106 then passes that token to point of interaction 114 as part of the transaction process. Point of interaction 114 may then send the token to mobile backend server 102 via a secure network connection. Mobile backend server 102 uses the token to determine the transaction information 112, which it then provides to point of interaction 114 over the secure network connection. One advantage to this method is that the transfer of the token from mobile backend server 102 to mobile device 106, and the transfer of the token from mobile device 106 to point of interaction 114, may happen over an unsecured network, since the token only represents sensitive information rather than includes sensitive information.

There are a variety of ways to generate a token that represents sensitive information. In one embodiment, the token may contain sensitive information that has been encrypted or encoded such that, when the token is received by mobile backend server 102, mobile backend server 102 can decrypt or decode the token to determine the transaction information. For example, the token may include sensitive information needed for the transaction that has been encrypted or encoded, in which case mobile backend server 102 need only decrypt or decode the token to get the transaction information directly. Alternatively, the token may include the identity of the user and a payment preference, in which case mobile backend server 102 may decrypt or decode the token to determine information that is then used to query database 108. The transaction information received from database 108 in response to the query is then sent to point of interaction 114. In one embodiment, the token generation algorithm or process may incorporate date, time, sequence number, or other non-static value for the purpose of protection against a “replay” exploit.

In another embodiment, mobile backend server 102 may generate a token based on an algorithm that does not consider or depend upon sensitive information at all. For example, mobile backend server 102 may generate a number according to a pseudo-random sequence. In this embodiment, mobile backend server 102 could maintain a lookup table that relates the number generated to the sensitive information, so that when mobile backend server 102 receives the token from point of interaction 114, mobile backend server 102 can go to the lookup table to retrieve the sensitive information that the token represents. In yet another embodiment, mobile device 106 may generate the token according to an algorithm known both to it and to mobile backend server 102, rather than having the token be generated by mobile backend server 102. In this embodiment, mobile device 106 may send to point of interaction 114 the self-generated token only or with additional information that, when ultimately received by mobile backend server 102, is used by mobile backend server 102 to help identify the user, account, etc., in order to determine which sensitive information should be then sent to point of interaction 114.

Authentication Information

In one embodiment, user information 104 includes authentication information that is used to authenticate the user's identity. Examples of authentication information include, but are not limited to: a digital signature of the user; biometric information provided by the user; a password, passcode, or personal information number (PIN) of the user; a geo-location of the user; information from the user's social network; a name of the user; an address of the user; or an identification number associated with the user. In one embodiment, the methods and systems described herein may perform multifactor authentication, e.g., authentication using multiple indicators of authenticity and/or authentication by multiple entities.

In one embodiment, the user of a mobile device 106 may perform a comprehensive authentication process prior to the time of performing an electronic transaction and perform a streamlined and/or simplified authentication process at the time of performing the electronic transaction. For example, a user of a mobile device 106 with a fingerprint scanner may authenticate himself or herself to the mobile device 106, which stores the fingerprint data and requires the user to provide sufficient information with which the mobile backend server 102 can verify that the person using the mobile device 106 is in fact the person that the user claims to be. For example, this rigorous process may be done when the user first sets up the mobile device 106, when the user registers with the mobile backend server 102, upon initiation by the user or other party to the transaction, etc. Once the user's fingerprint is authenticated by the mobile device 106, at the time of the electronic transaction, the user need only provide a fingerprint to the fingerprint scanner, which the mobile device 106 confirms matches the fingerprint that is associated with the purported user.

Shipping Information

In one embodiment, user information 104 includes information that indicates the user's shipping preference or other shipping instructions. For example, user information 104 may include a shipping address, a preferred carrier or package delivery service, a preferred shipping priority (e.g., ground, first class, next day air, etc.) or other shipping information.

Mobile backend server 102 may receive user information 104 directly from the user's mobile device 106, as shown in FIG. 1. In an alternative embodiment, mobile backend server 102 may receive user information 104 indirectly from mobile device 106, such as via a point of sale terminal. In this embodiment, mobile device 106 may provide user information 104 to the POS terminal, which forwards that information to mobile backend server 102.

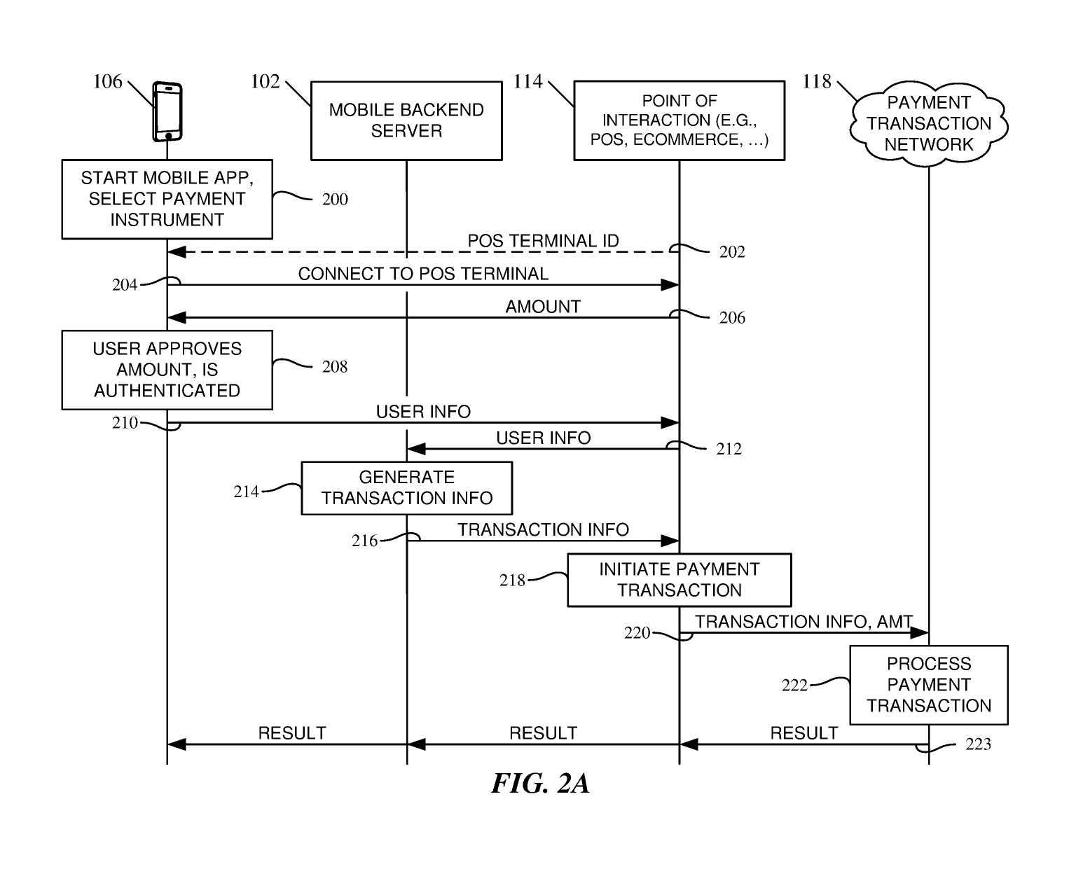

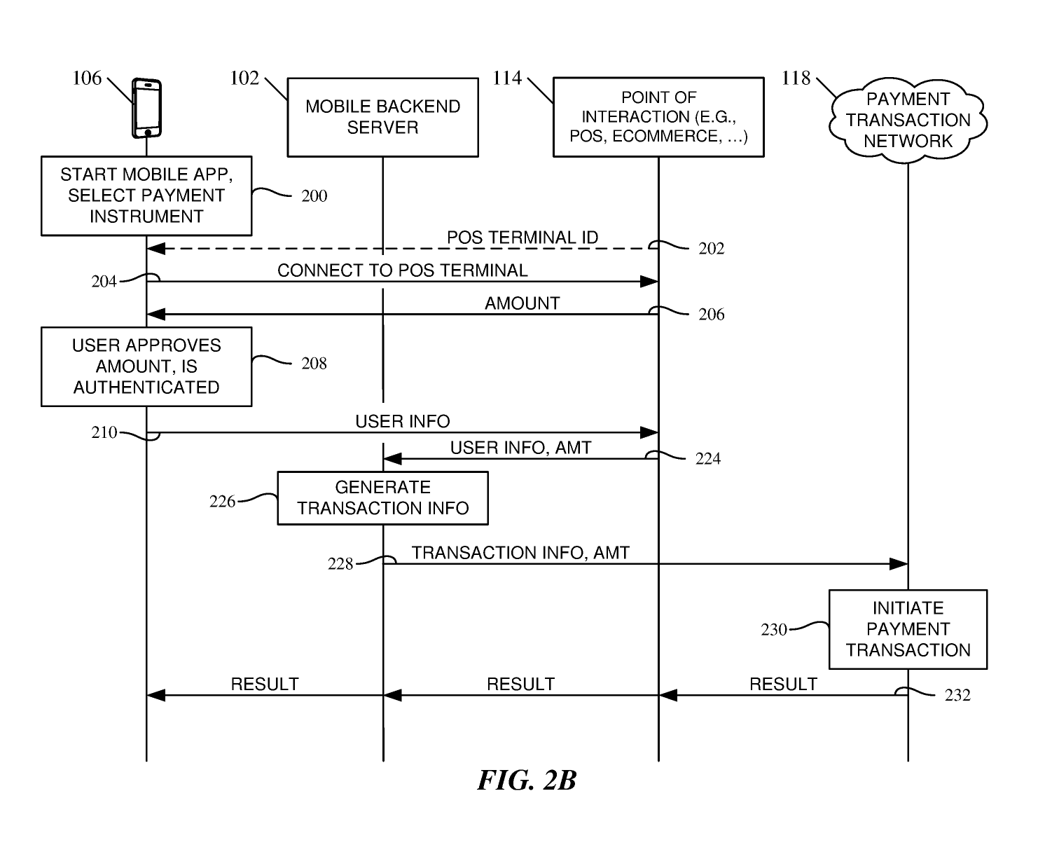

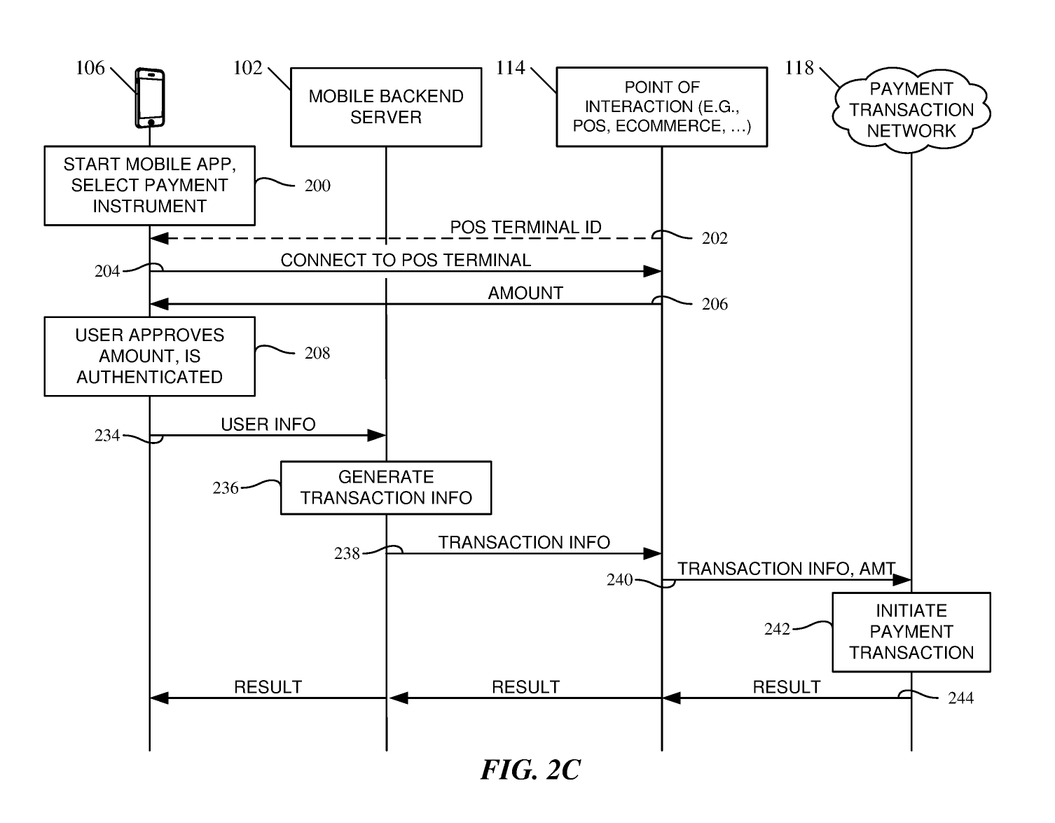

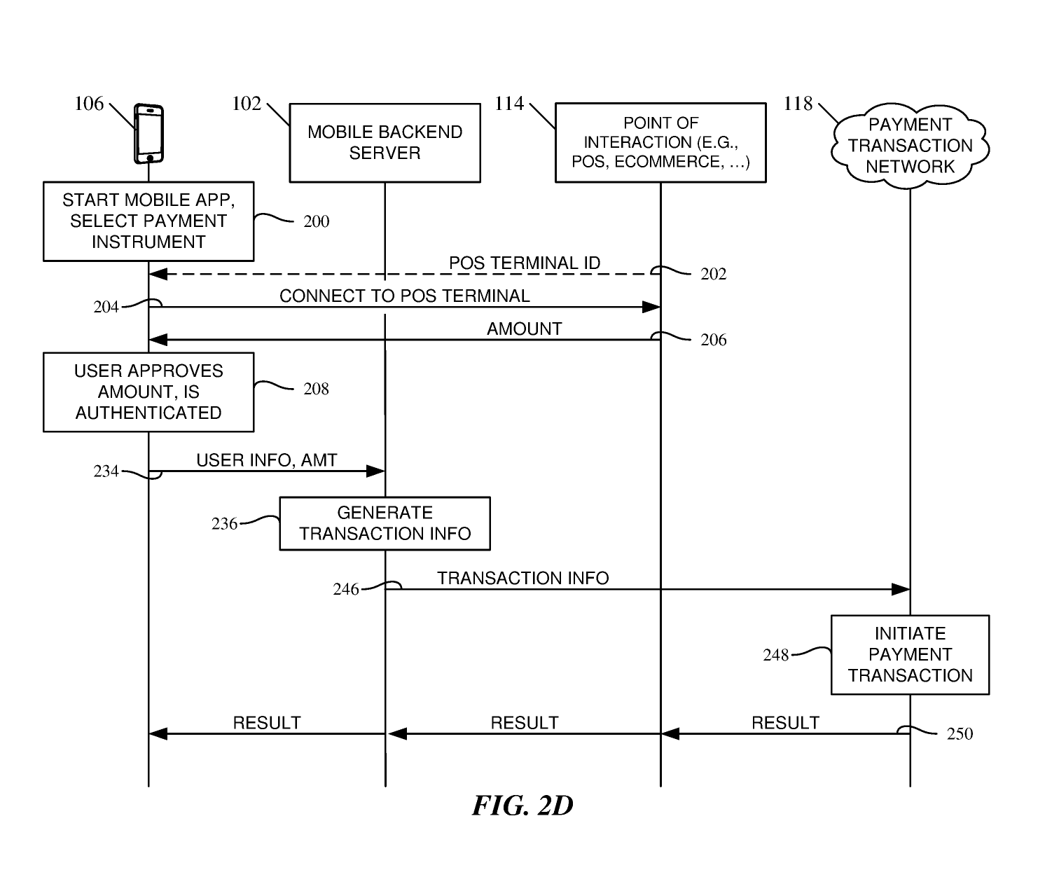

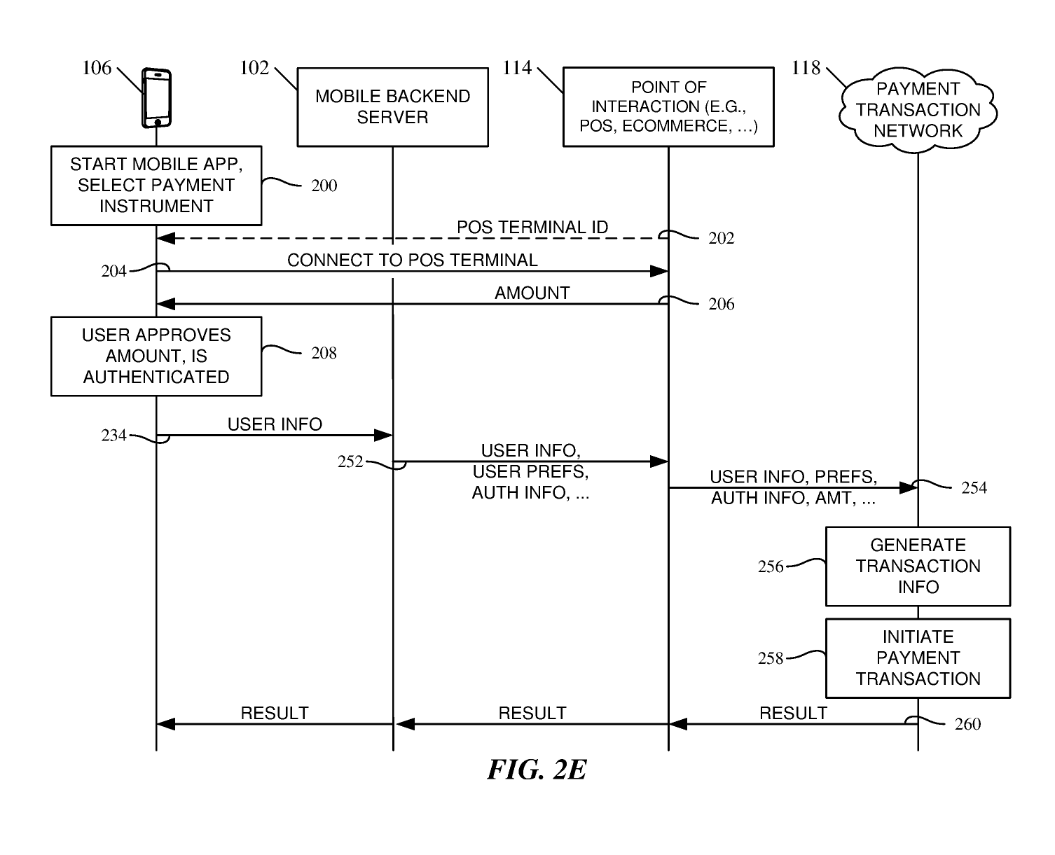

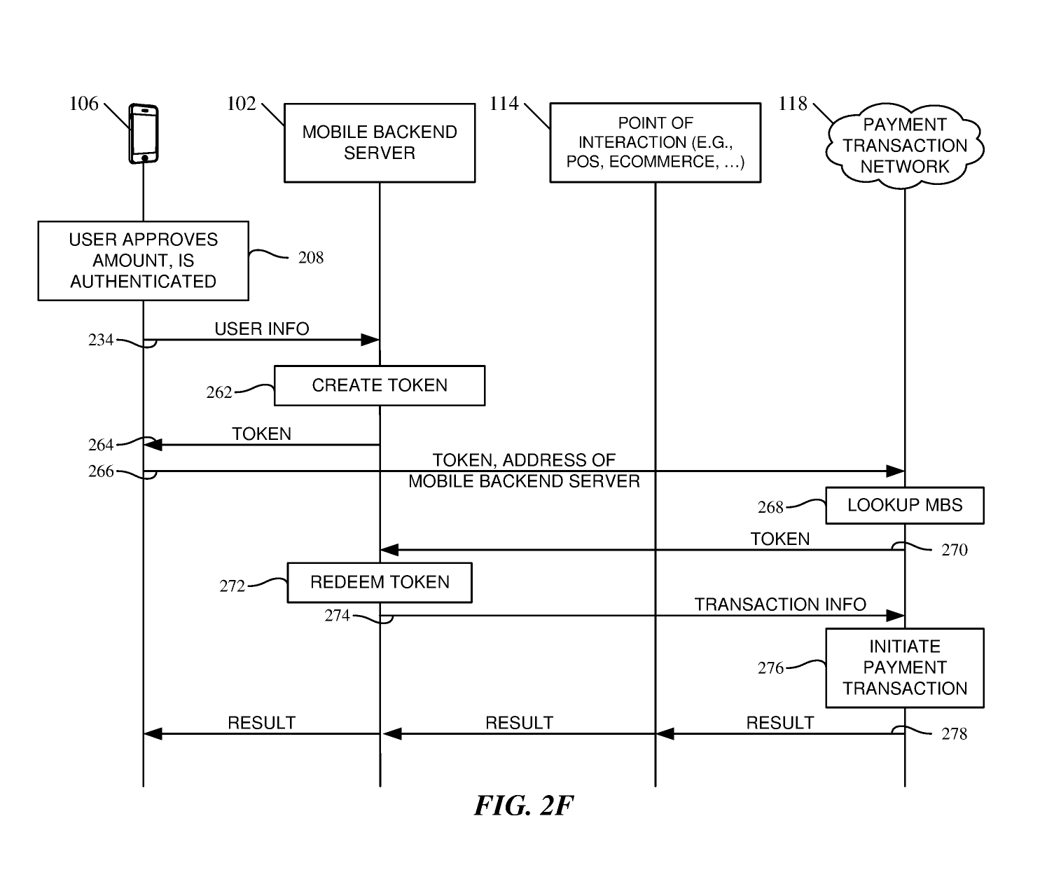

In one embodiment, mobile device 106 authenticates the user's identity before sending user information 104 to mobile backend server 102. Mobile device 106 may use a variety of means to authenticate the user, including, but not limited to, a digital signature of the user; biometric information provided by the user; a password, pass code, or personal information number (PIN) of the user; a geo-location of the user; information from the user's social network; a name of the user; an address of the user; or an identification number associated with the user. As will be described in more detail below starting with FIG. 2A, mobile device 106 may present to the user details about the transaction (e.g., amount, tax, selected payment instrument, etc.) so that the user may approve the transaction, in which case mobile device 106 sends user information 104 to mobile backend server 102. If the user does not approve the transaction, user information 104 is not sent to mobile backend server 102. (Mobile device 106 may send some notification that the user did not approve the transaction instead, for example.) The transaction details may be provided to mobile device 106 via a variety of means, including receiving them from mobile backend server 102, receiving them from a POS terminal or other point of interaction 114, or receiving them from the user, who manually enters the information.

In one embodiment, user authentication may be performed at the same time as the approval. For example, mobile device 106 may require the user to demonstrate approval by placing a finger or thumb on a fingerprint sensor on the mobile device, by entering a password, pass code, or PIN, and so on. Alternatively, authentication may happen before or after the approval process.

Transaction Information

In the embodiment just described above, user information 104 is used by mobile backend server 102 to query database 108 to get transaction information 112, but other embodiments are also contemplated. In one alternative embodiment, user information 104 is passed to point of interaction 114. Point of interaction 114 uses the user information to get transaction information 112 from database 108, either indirectly through mobile backend server 102 or directly (arrow 124). In another alternative embodiment, user information 104 is received by point of interaction 114, which forwards it to payment transaction network 118; payment transaction network 118 may use the user information to query database 108 (arrow 126). Likewise, payment transaction network may forward user information 104 to customer bank 120 or even to merchant bank 122, which may use that information to query database 108 (arrow 128 and 130, respectively) to retrieve transaction information 112, needed to perform the desired transaction.

Examples of the operation of system 100 will now be described in more detail.

FIGS. 2A, 2B, 2C, 2D, 2E, and 2F are signal messaging diagrams illustrating messages communicated among components of an exemplary system for using a consumer identity to perform electronic transactions according to embodiments of the subject matter described herein. FIGS. 2A through 2F will now be described with reference to the system shown in FIG. 1. The mobile device 106, mobile backend server 102, point of interaction 114 (in this case, a physical store/POS terminal), and payment network 118, shown in FIGS. 2A through 2F are essentially identical to their like-numbered counterparts in FIG. 1, and so their descriptions will not be repeated here.

For the purpose of illustration, in the embodiments illustrated in FIG. 2A through FIG. 2F, the electronic transaction is a payment transaction, but the same principles apply to non-payment transactions as well. In alternative embodiments, the transaction could be a loyalty or rewards program transaction, for example, but for the sake of illustration of the concepts described herein, a payment scenario is described.

FIG. 2A is a signal messaging diagram illustrating messages communicated among components of an exemplary system for using a consumer identity to perform electronic transactions according to one embodiment of the subject matter described herein.

At block 200, the user starts a mobile application for that purpose. In the embodiment illustrated in FIG. 2A, the user also selects a payment instrument, e.g., indicates a desire to use a credit card versus a debit card, a desire to use a card from bank A instead of from bank B, and so on. In scenarios where the user can use only one payment instrument, however, the “select payment instrument” step may be skipped.

In the embodiment illustrated in FIG. 2A, mobile device 106 receives information that identifies POS terminal 116 (message 202). This information may be conveyed to mobile device 106 in a variety of ways. For example, mobile device 106 may use its camera to scan this information presented as alphanumeric text or encoded in a QR code or bar code, which may displayed on or near the POS terminal 116, on a store website, or elsewhere. Mobile device 106 may receive this information wirelessly via radio frequency transmission (e.g., near field communication (NFC), Bluetooth™, Wi-Fi, Wi-Fi Direct, etc.) or infrared (IR) communications links. A user may manually enter this information into mobile device 106, and so on. The information may be provided by the POS terminal 114, by the store, by a website, etc.

Mobile device 106 may then connect to POS terminal 114 (message 204). This connection may a wireless or wired connection, and may use any connection protocol. The connection may be a stateful or stateless connection. In one embodiment, for example, mobile device 106 may establish a session with POS terminal 114.

POS terminal 114 provides to mobile device 106 information about the transaction (message 206), such as the amount of the transaction, taxes or surcharges levied, discounts applied, bonus points or rewards given, and so on.

At block 208, the user is given an opportunity to approve the transaction before proceeding. For example, the mobile app may display the transaction details to the user and ask for authorization to proceed with the transaction. At or near the same time, mobile device 106 may authenticate the user.

There are a variety of ways to authenticate a user. For example, mobile device 106 may require the user to enter a password, pass code, or PIN; mobile device 106 may require some biometric information to be provided by the user, such as to verify the user's fingerprint with a fingerprint sensor; mobile device 106 may require a digital signature of the user. Mobile device 106 may use other kinds of information to authenticate the user's identity, such as a geo-location of the user, information from the user's social network, a name of the user, an address of the user, or an identification number associated with the user, to name a few.

If the user is successfully authenticated, mobile device 106 can send user information that will be used to determine or generate transaction information. In the embodiment illustrated in FIG. 2A, mobile device 106 sends user information to POS terminal 114 (message 210), which forwards that information to mobile backend server 102 (message 212). The user information in message 210 may include payment information that is used to identify a payment instrument, authentication information that is used to authenticate the user's identity, shipping information that indicates the user's shipping preference or other shipping instructions, or other information.

At block 214, mobile backend server 102 uses the received information to generate transaction information. Referring to FIG. 1, for example, mobile backend server 102 may use user information 104 to query database 108 to determine transaction information 112.

Mobile backend server 102 then sends the transaction information to POS terminal 114 (message 216), which initiates a payment transaction (block 218). In the embodiment illustrated in FIG. 2A, POS terminal 114 forwards transaction information to payment network 118, along with other information needed to complete the transaction, such as the amount of the transaction, etc. (message 220).

At block 222, payment network 118 receives the transaction information and transaction amount, and uses it to initiate a payment transaction. Referring to FIG. 1, for example, the desired transaction may be a payment transaction that transfers funds from one bank 120 to another bank 122. Payment network 118 then notifies POS terminal 114 of the result of the transaction, which is forwarded to mobile device 106 via mobile backend server 102 (message 223).

FIG. 2B is a signal messaging diagram illustrating messages communicated among components of an exemplary system for using a consumer identity to perform electronic transactions according to another embodiment of the subject matter described herein. Block 200, messages 202, 204, and 206, block 208, and message 210 are essentially identical to their like-numbered counterparts in FIG. 2A, and therefore their descriptions will not be repeated here.

In the embodiment illustrated in FIG. 2B, however, mobile backend server 102 will send transaction information directly to payment network 118, bypassing POS terminal 114. Thus, in FIG. 2B, after POS terminal 114 receives user information in message 210, it forwards not only that information to mobile backend server 102 but also includes transaction details in that communication (message 224). In the embodiment illustrated in FIG. 2B, for example, message 224 includes not only user information but also the amount of the transaction.

In the embodiment illustrated in FIG. 2B, mobile backend server 102 receives the user information and amount, generates transaction information (block 226), and sends both the transaction information, including the transaction amount, directly to payment network 118 (message 228). In response, payment network 118 initiates a payment transaction (block 230) and reports to the result back to mobile device 106 (message 232).

FIG. 2C is a signal messaging diagram illustrating messages communicated among components of an exemplary system for using a consumer identity to perform electronic transactions according to yet another embodiment of the subject matter described herein. FIG. 2C illustrates an embodiment where mobile device 106 sends user information directly to mobile backend server 102 rather than indirectly through POS terminal 114. Block 200, messages 202, 204, and 206, and block 208 are essentially identical to their like-numbered counterparts in FIG. 2A, and therefore their descriptions will not be repeated here.

In the embodiment illustrated in FIG. 2C, after user approval and authentication at block 208, mobile device 106 sends user information directly to mobile backend server 102 (message 234). Mobile backend server 102 uses that information to generate transaction information (block 236), which it sends to POS terminal 114 (message 238). POS terminal 114 forwards that information, along with other transaction details (e.g., amount, tax, etc.) to payment network 118 (message 240). Payment network 118 then initiates a payment transaction (block 242), and reports the result back to mobile device 106 (message 244).

FIG. 2D is a signal messaging diagram illustrating messages communicated among components of an exemplary system for using a consumer identity to perform electronic transactions according to yet another embodiment of the subject matter described herein. Like FIG. 2C, FIG. 2D illustrates an embodiment where mobile device 106 sends user information directly to mobile backend server 102 rather than indirectly through POS terminal 114. Block 200, messages 202, 204, and 206, block 208, message 234, and block 236 are essentially identical to their like-numbered counterparts in FIG. 2C, and therefore their descriptions will not be repeated here.

In the embodiment illustrated in FIG. 2D, once mobile backend server 102 has generated transaction information (block 236), it sends that information directly to payment network 118 (message 246). Payment network 118 then initiates a payment transaction (block 248), and reports the result back to mobile device 106 (message 250).

Out of a recognition that mobile device 106, which authenticates the user, may deliberately or inadvertently fail to properly authenticate the user of the device (e.g., it may erroneously report an unauthorized user as an authorized user), payment network 118 may be provided with additional information by which the payment network (or a bank or other entity involved in the transaction) may perform its own authentication of the user. For example, payment network 118 may receive, along with transaction information, a digital signature of the user or other information that can be used to authenticate the user. This additional authentication information may be provided by mobile backend server 102, by mobile device 106, or by another entity entirely.

FIG. 2E is a signal messaging diagram illustrating messages communicated among components of an exemplary system for using a consumer identity to perform electronic transactions according to yet another embodiment of the subject matter described herein. FIG. 2E illustrates an embodiment in which the user information is passed to an entity within payment network 118 (represented rather simplistically in FIG. 2E as passing that information to the payment network itself rather than to an entity within the network), where that entity generates transaction information (e.g., by querying database 108) which it uses to initiate the payment transaction. Block 200, messages 202, 204, and 206, block 208, and message 234 are essentially identical to their like-numbered counterparts in FIG. 2C, and therefore their descriptions will not be repeated here.

In the embodiment illustrated in FIG. 2E, mobile device 106 passes the user information to mobile backend server 102, which may supplement that information with additional information, such as user payment preferences, user shipping preferences, and additional information needed to authorize the transaction. Mobile backend server 102 sends the user information and optional supplemental information to POS terminal 114 (message 252), which forwards that information to payment network 118 (message 254). In POS terminal 114 may provide additional information needed to perform the electronic transaction. In the embodiment illustrated in FIG. 2E, for example, POS terminal 114 also includes information such as the amount of the transaction, but other information, such as discount rates, membership or loyalty information, and so on, may be included.

At block 256, payment transaction network 118 uses some or all of the received information to generate transaction information. In one embodiment, payment transaction network 118 (or an entity within or connected to it) may query database 108 directly to get the needed transaction information (e.g., via connections 126, 128, or 130 in FIG. 1), initiate the payment transaction (block 258), and return the result (message 260).

FIG. 2F is a signal messaging diagram illustrating messages communicated among components of an exemplary system for using a consumer identity to perform electronic transactions according to yet another embodiment of the subject matter described herein. FIG. 2F illustrates an embodiment which uses a token to represent sensitive data rather than sending the sensitive data itself. In the embodiment illustrated in FIG. 2C, the interaction starts at block 208, but it should be noted that block 200 and messages 202, 204, and 206, such as are shown in FIG. 2E, are assumed to have already occurred. Block 208 and message 234 are essentially identical to their like-numbered counterparts in FIG. 2C, and therefore their descriptions will not be repeated here.

In the embodiment illustrated in FIG. 2F, upon receipt of the user information in message 234, mobile backend server 102 creates a token (block 262), which it sends to mobile device 106 (message 264). To complete the transaction, mobile device 106 transmits the token to the payment transaction network 118 (message 266). In the embodiment illustrated in FIG. 2F, mobile device 106 sends the token directly to payment transaction network 118, but in alternative embodiments, the token may be sent indirectly to payment transaction network 118, e.g. via POS terminal 114 or other network entity.

In one embodiment, the address of mobile backend server 102 may also be sent with the token so that the recipient of the token knows where to go to redeem the token, i.e., use the token to get the transaction information. In the embodiment illustrated in FIG. 2F, payment transaction network 118 looks up the address of mobile backend server 102 (block 268) and sends the token to mobile backend server 102 (message 270). Block 268 may include other processing steps performed in preparation for the transaction.

In the embodiment illustrated in FIG. 2F, in response to receiving the token from payment transaction network 118, mobile backend server 102 redeems the token (block 272) and sends the transaction information to payment transaction network 118 (message 274). Payment transaction network 118 initiates the payment transaction (block 276), and reports the result back to the user (message 278).

In one embodiment, at block 262, the token may be generated via a function which encodes or uses as an input transaction information. In this embodiment, when mobile backend server 102 receives the token in message 270, mobile backend server 102 may decode the received token to retrieve the transaction information encoded within. In an alternative embodiment, at block 262, the token may be generated via an algorithm that does not consider the transaction information at all. For example, the token may be created via a pseudo-random sequence generator, or using a combination of current date, time, a counter value, or other information. In this embodiment, mobile backend server may store the generated token in a lookup table that associates the token value with the particular user's transaction information, so that when the token is received via message 270, mobile backend server 102 may use the token to look up the transaction information, which is sent out in message 274.

In yet another embodiment, mobile backend server 102 may generate the token using an algorithm or function that is also known to an entity within payment transaction network 118. For example, the token may be encrypted using the mobile backend server's private key and decrypted by payment transaction network 118 using the mobile backend server's public key. Likewise, the mobile backend server 102 may sign the token using a public key of payment transaction network 118, so that when payment transaction network 118 receives the token in message 266, it can authenticate the token using its private key. In these embodiments where both mobile backend server 102 and payment transaction network 118 know the algorithm or function, payment transaction network 118 can redeem the token by itself, without the need to contact mobile backend server 102, which obviates the need for message 270, block 272, or message 274 in FIG. 2F.

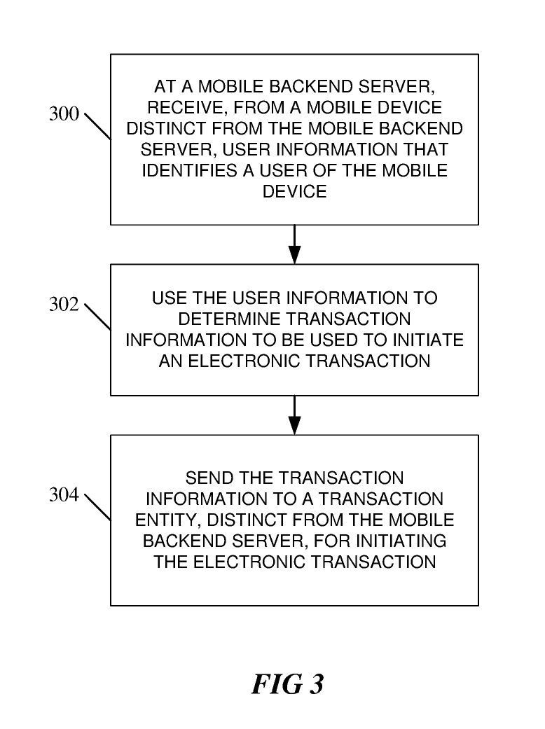

FIG. 3 is a flow chart illustrating an exemplary process for using a consumer identity to perform electronic transactions according to an embodiment of the subject matter described herein. In the embodiment illustrated in FIG. 3, the method includes:

At block 300, a mobile backend server receives, from a mobile device distinct from the mobile backend server, user information that identifies a user of the mobile device. Referring to FIG. 1, for example, mobile backend server 102 may receive, from mobile device 106, user information 104 that identifies a user of mobile device 106.

At block 302, the mobile backend server uses the user information to determine transaction information to be used to initiate an electronic transaction. Referring to FIG. 1, for example, mobile backend server 102 may use user information 104 to query database 108 to determine transaction information 112. The desired transaction may be a payment or non-payment transaction.

At block 304, the mobile backend server sends the transaction information to a point of interaction, distinct from the mobile backend server, for initiating the electronic transaction. Referring to FIG. 1, for example, mobile backend server 102 may send transaction information 112 to point of interaction 114, which sends that information to payment transaction network 118. The example embodiments described herein are intended to be illustrative and not limiting. It is important to note that the order of the actions and messages described above are for illustration only and are not intended to be limiting. Furthermore, embodiments having additional steps or fewer steps are also within the scope of the subject matter described herein.

### Embodiment 1

A method for using a consumer identity to perform electronic transactions, the method comprising: at a mobile backend server: receiving user information that identifies a user of a mobile device distinct from the mobile backend server; using the user information to determine transaction information to be used to initiate an electronic transaction; and sending the transaction information to a point of interaction, distinct from the mobile device and the mobile backend server, for initiating the electronic transaction.

### Embodiment 2

The method of embodiment 1 wherein the transaction information includes at least some of the user information.

### Embodiment 3

The method of embodiment 1 wherein the user information includes payment information that is used to identify a payment instrument.

### Embodiment 4

The method of embodiment 3 wherein the payment information comprises legacy payment information.

### Embodiment 5

The method of embodiment 3 wherein the payment information comprises a pointer to legacy information and wherein the mobile backend server uses the pointer to determine legacy payment information.

### Embodiment 6

The method of embodiment 3 wherein the payment information comprises a token that represents legacy payment information, which the mobile backend server sends as part of the transaction information.

### Embodiment 7

The method of embodiment 3 wherein the payment information identifies a type of payment instrument to be used.

### Embodiment 8

The method of embodiment 1 wherein the user information includes authentication information that is used to authenticate the user's identity.

### Embodiment 9

The method of embodiment 1 wherein the authentication information comprises an indication that the user was authenticated.

### Embodiment 10

The method of embodiment 8 wherein the authentication information comprises at least one of: a digital signature of the user; biometric information provided by the user; a password, passcode, or personal information number (PIN) of the user; a geo-location of the user; information from the user's social network; a name of the user; an address of the user; or an identification number associated with the user.

### Embodiment 11

The method of embodiment 1 wherein the user information includes the user's shipping preference information.

### Embodiment 12

The method of embodiment 1 wherein the user information is received from the mobile device.

### Embodiment 13

The method of embodiment 12 wherein the user information is received from the mobile device via a point of sale terminal.

### Embodiment 14

The method of embodiment 12 comprising, at the mobile device, authenticating the user before sending the user information.

### Embodiment 15

The method of embodiment 14 wherein authenticating the user includes using at least one of: a digital signature of the user; biometric information provided by the user; a password, passcode, or personal information number (PIN) of the user; a geo-location of the user; information from the user's social network; a name of the user; an address of the user; or an identification number associated with the user.

### Embodiment 16

The method of embodiment 12 wherein, prior to sending the user information to the mobile backend server, the mobile device determines transaction details.

### Embodiment 17

The method of embodiment 16 wherein the transaction details are provided to the mobile device by the mobile backend server or by a point of sale terminal.

### Embodiment 18

The method of embodiment 16 wherein at least some of the transaction details are presented by the mobile device to the user for approval, and wherein the user information is sent to the mobile backend server only if the mobile device receives the user's approval.

### Embodiment 19

The method of embodiment 16 wherein the mobile device includes at least some of the transaction details with the user information that is sent to the mobile backend server.

### Embodiment 20

The method of embodiment 1 wherein sending the transaction information to a point of interaction comprises a sending the transaction information to a point of sale terminal, which forwards the transaction information to a payment network.

### Embodiment 21

The method of embodiment 1 wherein sending the transaction information to a point of interaction comprises sending the transaction directly to a payment network.

### Embodiment 22

The method of embodiment 1 wherein the electronic transaction comprises a payment or non-payment transaction.

### Embodiment 23

The method of embodiment 1 wherein the electronic transaction comprises at least one of: a payment or purchase; a credit transaction; a debit transaction; a prepaid transaction; a deposit; a withdrawal; a money transfer; a transaction involving a loyalty program; a transaction involving a rewards program; and a transaction involving a diet, health, or fitness program.

### Embodiment 24

The method of embodiment 1 wherein the electronic transaction comprises a “card present” transaction.

### Embodiment 25

The method of embodiment 1 wherein the point of interaction comprises at least one of: a point of sale (POS) terminal, an ecommerce site, a mobile commerce site, a kiosk, a vending machine, and a parking meter.

### Embodiment 26

A system for using a consumer identity to perform electronic transactions, the system comprising: a database for associating a user with transaction information; and a mobile backend server for receiving user information that identifies a user of a mobile device distinct from the mobile backend server, using the user information to query the database to determine transaction information to be used to initiate an electronic transaction, and sending the transaction information to a point of interaction, distinct from the mobile device and the mobile backend server, for initiating the electronic transaction.

### Embodiment 27

The system of embodiment 26 wherein the transaction information includes at least some of the user information.

### Embodiment 28

The system of embodiment 26 wherein the user information includes payment information that is used to identify a payment instrument.

### Embodiment 29

The system of embodiment 28 wherein the payment information comprises legacy payment information.

### Embodiment 30

The system of embodiment 28 wherein the payment information comprises a pointer to legacy information and wherein the mobile backend server uses the pointer to determine legacy payment information.

### Embodiment 31

The system of embodiment 28 wherein the payment information comprises a token that represents legacy payment information, which the mobile backend server sends as part of the transaction information.

### Embodiment 32

The system of embodiment 28 wherein the payment information identifies a type of payment instrument to be used.

### Embodiment 33

The system of embodiment 26 wherein the user information includes authentication information that is used to authenticate the user's identity.

### Embodiment 34

The system of embodiment 33 wherein the authentication information comprises at least one of: a digital signature of the user; biometric information provided by the user; a password, passcode, or personal information number (PIN) of the user; a geo-location of the user; information from the user's social network; a name of the user; an address of the user; or an identification number associated with the user.

### Embodiment 35

The system of embodiment 26 wherein the user information includes the user's shipping preference information.

### Embodiment 36

The system of embodiment 26 wherein the user information is received from the mobile device.

### Embodiment 37

The system of embodiment 36 wherein the user information is received from the mobile device via a point of sale terminal.

### Embodiment 38

The system of embodiment 36 comprising, at the mobile device, authenticating the user before sending the user information.

### Embodiment 39

The system of embodiment 38 wherein authenticating the user includes using at least one of: a digital signature of the user; biometric information provided by the user; a password, passcode, or personal information number (PIN) of the user; a geo-location of the user; information from the user's social network; a name of the user; an address of the user; or an identification number associated with the user.

### Embodiment 40

The system of embodiment 36 wherein, prior to sending the user information to the mobile backend server, the mobile device determines transaction details.

### Embodiment 41

The system of embodiment 40 wherein the transaction details are provided to the mobile device by the mobile backend server or by a point of sale terminal.

### Embodiment 42

The system of embodiment 40 wherein at least some of the transaction details are presented by the mobile device to the user for approval, and wherein the user information is sent to the mobile backend server only if the mobile device receives the user's approval.

### Embodiment 43

The system of embodiment 40 wherein the mobile device includes at least some of the transaction details with the user information that is sent to the mobile backend server.

### Embodiment 44

The system of embodiment 26 wherein sending the transaction information to a point of interaction comprises a sending the transaction information to a point of sale terminal, which forwards the transaction information to a payment network.

### Embodiment 45

The system of embodiment 26 wherein sending the transaction information to a point of interaction comprises sending the transaction directly to a payment network.

### Embodiment 46

The system of embodiment 26 wherein the electronic transaction comprises a payment or non-payment transaction.

### Embodiment 47

The system of embodiment 26 wherein the electronic transaction comprises at least one of: a payment or purchase; a credit transaction; a debit transaction; a prepaid transaction; a deposit; a withdrawal; a money transfer; a transaction involving a loyalty program; a transaction involving a rewards program; and a transaction involving a diet, health, or fitness program.

### Embodiment 48

The system of embodiment 26 wherein the electronic transaction comprises a “card present” transaction.

### Embodiment 49

The system of embodiment 26 wherein the point of interaction comprises at least one of: a point of sale (POS) terminal, an ecommerce site, a mobile commerce site, a kiosk, a vending machine, and a parking meter.

### Embodiment 50

A computer program product comprising: a non-transitory computer readable storage medium having computer readable code embodied therewith, the computer readable code comprising: computer readable program code configured for: receiving, at a mobile backend server, user information that identifies a user of a mobile device distinct from the mobile backend server; using, at the mobile backend server, the user information to determine transaction information to be used to initiate an electronic transaction; and sending, by the backend server, the transaction information to a point of interaction, distinct from the mobile device and the mobile backend server, for initiating the electronic transaction.

What is claimed is:

1. A method for using a consumer identity to perform electronic transactions, the method comprising:
at a mobile backend server:
receiving user information that identifies a user of a mobile device distinct from the mobile backend server;
using the user information to determine transaction information to be used to initiate an electronic transaction; and
sending the transaction information to a point of interaction, distinct from the mobile backend server, for initiating the electronic transaction.

2. The method of claim 1 wherein the mobile device comprises one of:
a cellphone;
a tablet;
a watch;
a wearable or portable computer; or
a vehicle with mobile communication capability.

3. The method of claim 1 wherein the transaction information includes at least some of the user information.

4. The method of claim 1 wherein the user information includes payment information that is used to identify a payment instrument.

5. The method of claim 4 wherein the payment information comprises legacy payment information.

6. The method of claim 4 wherein the payment information comprises a pointer to legacy information and wherein the mobile backend server uses the pointer to determine legacy payment information.

7. The method of claim 4 wherein the payment information comprises a token that represents legacy payment information, which the mobile backend server sends as part of the transaction information.

8. The method of claim 4 wherein the payment information identifies a type of payment instrument to be used.

9. The method of claim 1 wherein the user information includes authentication information that is used to authenticate the user's identity.

10. The method of claim 1 wherein the authentication information comprises an indication that the user was authenticated.

11. The method of claim 9 wherein the authentication information comprises at least one of: a digital signature of the user; biometric information provided by the user; a password, passcode, or personal information number (PIN) of the user; a geo-location of the user; information from the user's social network; a name of the user; an address of the user; or an identification number associated with the user.

12. The method of claim 1 wherein the user information includes the user's shipping preference information.

13. The method of claim 1 wherein the user information is received from the mobile device.

14. The method of claim 13 wherein the user information is received from the mobile device via a point of sale terminal.

15. The method of claim 13 comprising, at the mobile device, authenticating the user before sending the user information.

16. The method of claim 15 wherein authenticating the user includes using at least one of: a digital signature of the user; biometric information or the user; a password, passcode, or personal information number (PIN) of the user; a geo-location of the user; information from the user's social network; a name of the user; an address of the user; or an identification number associated with the user.

17. The method of claim 13 wherein, prior to sending the user information to the mobile backend server, the mobile device determines transaction details.

18. The method of claim 17 wherein the transaction details are provided to the mobile device by the mobile backend server or by a point of sale terminal.

19. The method of claim 17 wherein at least some of the transaction details are presented by the mobile device to the user for approval, and wherein the user information is sent to the mobile backend server only if the mobile device receives the user's approval.

20. The method of claim 17 wherein the mobile device includes at least some of the transaction details with the user information that is sent to the mobile backend server.

21. The method of claim 1 wherein sending the transaction information to a point of interaction comprises a sending the transaction information to a point of sale terminal, which forwards the transaction information to a payment network.

22. The method of claim 1 wherein sending the transaction information to a point of interaction comprises sending the transaction directly to a payment network.

23. The method of claim 1 wherein the electronic transaction comprises a payment or non-payment transaction.

24. The method of claim 1 wherein the electronic transaction comprises at least one of: a payment or purchase; a credit transaction; a debit transaction; a prepaid transaction; a deposit; a withdrawal; a money transfer; a transaction involving a loyalty program; a transaction involving a rewards program; and a transaction involving a diet, health, or fitness program.

25. The method of claim 1 wherein the electronic transaction comprises a “card present” transaction.

26. The method of claim 1 wherein the point of interaction comprises at least one of: an attended or unattended point of sale (POS) payment terminal, a POS cash register, a mobile POS terminal, an ecommerce site, a mobile commerce site, a kiosk, a vending machine, a tablet computer, and a parking meter.

27. The method of claim 1 wherein the point of interaction comprises an image with an OCR code that contains information associated with the object of the transaction.

28. The method of claim 1 wherein the point of interaction comprises an image of the object of the transaction with information associated with the object of the transaction steganographically embedded within the image.

29. The method of claim 1 wherein the mobile device is the point of interaction.

30. A system for using a consumer identity to perform electronic transactions, the system comprising:
a database for associating a user with transaction information; and
a mobile backend server for receiving user information that identifies a user of a mobile device distinct from the mobile backend server, using the user information to query the database to determine transaction information to be used to initiate an electronic transaction, and sending the transaction information to a point of interaction, distinct from the mobile backend server, for initiating the electronic transaction.

31. The system of claim 30 wherein the mobile device comprises one of:
a cellphone;
a tablet;
a watch;
a wearable or portable computer; or
a vehicle with mobile communication capability.

32. The system of claim 30 wherein the transaction information includes at least some of the user information.

33. The system of claim 30 wherein the user information includes payment information that is used to identify a payment instrument.

34. The system of claim 33 wherein the payment information comprises legacy payment information.

35. The system of claim 33 wherein the payment information comprises a pointer to legacy information and wherein the mobile backend server uses the pointer to determine legacy payment information.

36. The system of claim 33 wherein the payment information comprises a token that represents legacy payment information, which the mobile backend server sends as part of the transaction information.

37. The system of claim 33 wherein the payment information identifies a type of payment instrument to be used.

38. The system of claim 30 wherein the user information includes authentication information that is used to authenticate the user's identity.

39. The system of claim 38 wherein the authentication information comprises at least one of: a digital signature of the user; biometric information provided by the user; a password, passcode, or personal information number (PIN) of the user; a geo-location of the user; information from the user's social network; a name of the user; an address of the user; or an identification number associated with the user.

40. The system of claim 30 wherein the user information includes the user's shipping preference information.

41. The system of claim 30 wherein the user information is received from the mobile device.

42. The system of claim 41 wherein the user information is received from the mobile device via a point of sale terminal.

43. The system of claim 41 comprising, at the mobile device, authenticating the user before sending the user information.

44. The system of claim 43 wherein authenticating the user includes using at least one of: a digital signature of the user; biometric information provided by the user; a password, passcode, or personal information number (PIN) of the user; a geo-location of the user; information from the user's social network; a name of the user; an address of the user; or an identification number associated with the user.

45. The system of claim 41 wherein, prior to sending the user information to the mobile backend server, the mobile device determines transaction details.

46. The system of claim 45 wherein the transaction details are provided to the mobile device by the mobile backend server or by a point of sale terminal.

47. The system of claim 45 wherein at least some of the transaction details are presented by the mobile device to the user for approval, and wherein the user information is sent to the mobile backend server only if the mobile device receives the user's approval.

48. The system of claim 45 wherein the mobile device includes at least some of the transaction details with the user information that is sent to the mobile backend server.

49. The system of claim 30 wherein sending the transaction information to a point of interaction comprises a sending the transaction information to a point of sale terminal, which forwards the transaction information to a payment network.

50. The system of claim 30 wherein sending the transaction information to a point of interaction comprises sending the transaction directly to a payment network.

51. The system of claim 30 wherein the electronic transaction comprises a payment or non-payment transaction.

52. The system of claim 30 wherein the electronic transaction comprises at least one of: a payment or purchase; a credit transaction; a debit transaction; a prepaid transaction; a deposit; a withdrawal; a money transfer; a transaction involving a loyalty program; a transaction involving a rewards program; and a transaction involving a diet, health, or fitness program.

53. The system of claim 30 wherein the electronic transaction comprises a “card present” transaction.

54. The system of claim 30 wherein the point of interaction comprises at least one of: an attended or unattended point of sale (POS) payment terminal, a POS cash register, a mobile POS terminal, an ecommerce site, a mobile commerce site, a kiosk, a vending machine, a tablet computer, and a parking meter.

55. The system of claim 30 wherein the point of interaction comprises an image with an OCR code that contains information associated with the object of the transaction.

56. The system of claim 30 wherein the point of interaction comprises an image with information associated with the object of the transaction steganographically embedded within the image.

57. The system of claim 30 wherein the mobile device is the point of interaction.

58. A non-transitory computer readable medium storing software instructions that when executed by one or more processors of a mobile backend server cause the mobile backend server to:
receive user information that identifies a user of a mobile device distinct from the mobile backend server;
use the user information to determine transaction information to be used to initiate an electronic transaction; and
send the transaction information to a point of interaction, distinct from the mobile backend server, for initiating the electronic transaction.
